(19) United States
(12) Patent Application Publication
(10) Pub. No.: US 2005/0132264 A1
(43) Pub. Date: Jun. 16, 2005

(54) System and method for intelligent transcoding

(76) Inventors: Ajit P. Joshi, Portland, OR (US); Dzung D. Tran, Beaverton, OR (US); Kenneth L. Knowlson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/737,141

(22) Filed: Dec. 15, 2003

(51) Int. Cl. G06F 15/16; G06F 15/00; G06F 17/00; G06F 17/21; G06F 17/24

(52) U.S. Cl. 715/500.1; 709/231

(57) ABSTRACT

A system and method for intelligent transcoding: A user is enabled to select a media item that the user desires to have played on a particular rendering device on a network. The media item is then requested from a service provider. Upon receiving the media item, it is determined whether the media item needs intelligent transcoding to be played on the particular rendering device. If the media item needs intelligent transcoding, then the media item is intelligently transcoded. Intelligent transcoding includes one or more of transcoding, transcaling, transrating, transformatting, and transcripting. The media item is then streamed to the particular rendering device.

### BACKGROUND OF THE INVENTION

1. Field of the Invention

The present invention is generally related to transcoding. More particularly, the present invention is related to a system and method for intelligently transcoding video and audio streams to support rendering devices.

2. Description

Tools exist today that convert from one media format to another, such as, for example, Audio Video Interleave (AVI) to Motion Picture Expert Group (MPEG). The tools that exist today only do the conversion. They do not take into consideration bandwidth requirements, network usage, and/or what type of media is supported by the rendering device. In other words, they do not utilize the available resources in a given subsystem effectively.

Thus, what is needed is a system and method for converting from one media format to another that takes into consideration bandwidth requirements, network usage, and the type of media that is supported by the rendering device. What is also needed is a system and method for converting from one media format to another that effectively utilizes the available resources in the subsystem in which it is delivered. What is further needed is a system and method for converting from one media format to another without user intervention.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a diagram illustrating an exemplary home network in which the present invention may be implemented according to an embodiment of the present invention.

FIG. 2 is a diagram illustrating the factors involved for providing intelligent transcoding of video and audio streams from one format to another according to an embodiment of the present invention.

FIG. 3 is a block diagram of an exemplary intelligent transcoding engine according to an embodiment of the present invention.

FIG. 4A is a flow diagram illustrating an exemplary method for intelligent transcoding of video and audio streams from one format to another according to an embodiment of the present invention.

FIG. 4B is a flow diagram illustrating an exemplary method for determining whether intelligent transcoding of video and audio streams may be performed according to an embodiment of the present invention.

FIG. 5 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a system and method for providing intelligent transcoding of video and audio streams from a first data format to a second data format. The second data format is supported by the rendering device in which the video and/or audio streams are to be played. Intelligent transcoding includes, but is not limited to, decoding, encoding, resolution, and bit rate. Intelligent transcoding occurs without user intervention.

Embodiments of the present invention are described as being implemented in an extended wireless PC (personal computer) home environment. An extended wireless PC home environment refers to a home network environment in which a PC is used to extend digital media and information access throughout the home using wireless technology. Although embodiments of the present invention are described using a PC to extend digital media and information access throughout the home, one skilled in the relevant art(s) would know that embodiments of the present invention may also be implemented in a home or a business environment that incorporates other types of computing devices, such as, but not limited to, a media center, a set top box, a home server, a workstation, etc., to extend digital media and information access throughout the home or business using both wired and wireless-technology.

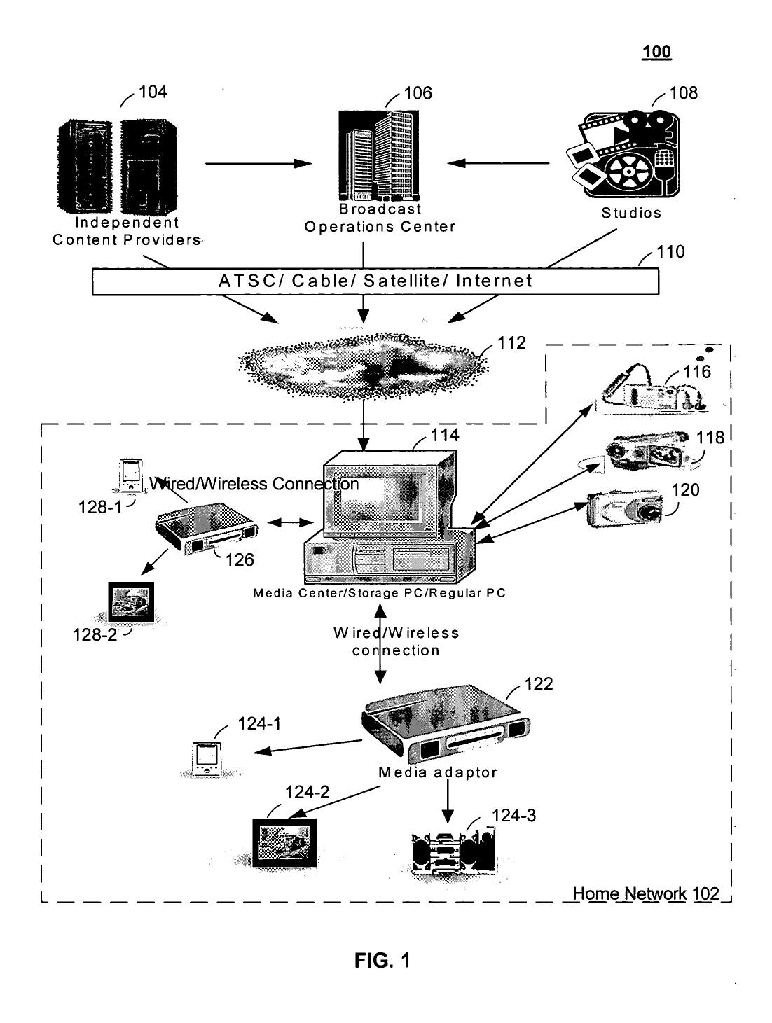

FIG. 1 is a diagram illustrating an exemplary home network system in which the present invention may be implemented according to an embodiment of the present invention. Home network system 100 may include a home network 102 that receives multimedia content over a wide area network (WAN) 112 from content providers, such as, but not limited to, independent content providers 104, broadcast operations centers 106, and studios 108. In one embodiment, independent content providers 104 and studios 108 may send content to broadcast operations centers 106 to format the content and send the content to home network 102. In one embodiment, content may come directly from independent content providers 104, broadcast operations centers 106, and studios 108 to home network 102. The content may be provided to home network 102 using one or more systems 110, such as, but not limited to, a cable system using a coax cable connection, a satellite system using a satellite connection, an Internet service using a dial-in connection, a digital telephone connection such as DSL (Digital Subscriber Line), a high speed cable modem connection, etc., and an ATSC (Advanced Television Systems Committee) system using a high definition (HD) connection. The ATSC/Cable/Satellite/Internet systems 110 obtain information from independent content providers 104, broadcast operations centers 106, and studios 108 to enable audio/video information to be transferred to home network 102.

Home network 102 uses a PC 114 to extend digital multimedia content and information received from independent content providers 104, broadcast operations centers 106, and studios 108 throughout the home using wired and/or wireless technology. Although a PC is used to extend digital multimedia content and information, other types of computing devices may also be used, such as, but not limited to, a media center, a set-top box, a workstation, a home server, etc. Home network 102 may be coupled to WAN 112 via a connection (not shown), such as, a dial-in connection, a high speed cable modem connection, a digital subscriber line (DSL) connection, a satellite connection, a HD connection, and/or any other means capable of connecting home network 102 to WAN 112.

Home network 102 includes media renderers 122 and 126, and a plurality of rendering devices 124 and 128. Media renderers 122 and 126 enable an electrical connection between devices not ordinarily intended for use together. For example, media renderer 122 electrically connects PC 114 to rendering devices 124. Media renderer 126 electrically connects PC 114 to rendering devices 128. Rendering devices 124 and 128 utilize media renderers 122 and 126, respectively, in order to receive audio/video input. Rendering devices 124 may include, but are not limited to, a personal digital assistant (PDA) 124-1, a television 124-2, and a stereo system 124-3, all of which are well known in the relevant art(s). Rendering devices 128 may include, but are not limited to, a personal digital assistant (PDA) 128-1 and a television 128-2.

In one embodiment, PDA 124-1 and PDA 128-1 may include wireless connections, such as, but not limited to, Bluetooth. In this embodiment, PDA 124-1 and PDA 128-1 may electrically connect to PC 114 via a wireless connection, thus, eliminating the need to connect PDA 124-1 to PC 114 through media renderer 122 and PDA 128-1 to PC 114 through media renderer 126.

In one embodiment, PC 114 may also receive digital multimedia data from other digital devices, such as, but not limited to, an MP3 player 116, a digital camcorder 118, and a digital camera 120. The digital multimedia data received from these digital devices may be rendered on one or more of rendering devices 124-1, 124-2, and 124-3 via PC 114.

In one embodiment, MP3 player 116, digital camcorder 118, and digital camera 120 may act as rendering devices and/or storage devices. Multimedia content from independent content providers 104, broadcast operations centers 106, and studios 108, may be streamed to any one of devices 116, 118, and 120 for storing and/or rendering the media content.

As previously indicated, embodiments of the present invention provide a method for intelligently transcoding video and audio streams from a first data format to a second data format. The second data format is supported by the rendering device on which the audio and/or video streams are to be played. Video and audio come in many different formats. Different service providers and different manufacturers of rendering devices may provide their content in many different formats, such as, for example, MPEG-1 (Motion Pictures Expert Group—1), MPEG-2 (Motion Pictures Expert Group—2), AVI (Audio/Video Interleave), MPEG-4 (Motion Pictures Expert Group—4), Program Stream, Transport Stream (for MPEG A/V (Audio/Video)), DV (Digital Video), DivX, Real A/V (Real Audio/Video), WMV/WMA (Windows Media Video/Windows Media Audio developed by Microsoft Corporation), etc. These are just a few of the media formats available. All rendering devices do not support all of the media formats; hence, there is a need to convert media from one format to another format to enable interoperability across media devices. New codecs evolve at a very fast rate than their penetration into the hardware world. It therefore becomes almost impossible to achieve interoperability if conversion from one media format to another media format is not enabled.

When a user of a rendering device, such as one of rendering devices 124-1, 124-2, 124-3, 128-1, or 128-2 wants to play a particular media selection in the home network environment, such as in home network 102, intelligent transcoding determines the supported media format(s) that the selected rendering device supports. For example, using UPnP (Universal Plug and Play) control points and discovery methods, information regarding rendering device capabilities may be obtained. UPnP is well known to those skilled in the relevant art(s). One skilled in the relevant art(s) would also know that other methods for obtaining information about the capabilities of rendering device are available, such as, for example, using a metadata server to discover rendering device capabilities. Intelligent transcoding analyzes network properties, along with supported media types on the rendering device, and decides which format to transcode the media content into for playing on the rendering device. Accordingly, intelligent transcoding will transcode the media content and broadcast or stream it in the given network environment to the appropriate rendering device.

In a home network environment, networked devices have limited rendering and decoding capabilities. The home network also has limited resources, such as limited dynamic memory, processing load, and available network bandwidth. Intelligent transcoding considers (1) the type of media that is supported by both the server devices and the rendering devices; and (2) network capabilities, such as network bandwidth requirements, processor load, and available memory, to determine if transcoding is possible and, if it is possible, transcodes the media in a proficient manner.

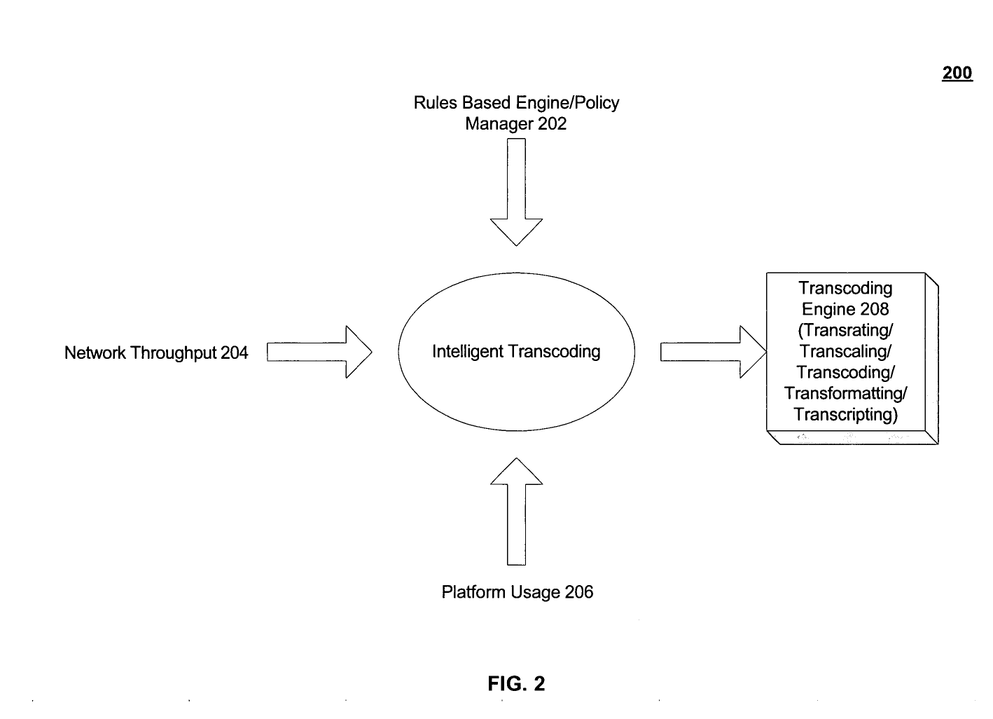

FIG. 2 is a diagram 200 illustrating the components involved in performing intelligent transcoding according to an embodiment of the present invention. Intelligent transcoding requires the ability to perform transrating, transcaling, transformatting, transcripting, and transcoding. Transrating is the process of changing or reducing the bitrate of the source content. Transcaling is the process of changing the resolution of the source content. Transformatting is the process of converting the packaging of the media format to another packaging format. Transcripting is the process of converting from one Digital Rights Management (DRM)/copy protection scheme to another DRM/copy protection scheme. Transcoding is the process of converting one media format into another media format. The components involved in performing intelligent transcoding include a rules based engine 202 (also referred to as policy manager 202), a network throughput engine 204, and a platform usage engine 206. Rules based engine 202, network throughput engine 204, and platform usage engine 206 each provide information to a transcoding engine 208. The information provided enables transcoding engine 208 to perform intelligent transcoding. In other words, transcoding engine uses the information from rules based engine 202, network throughput engine 204, and platform usage engine 206 to determine whether transrating, transcoding, and/or transcaling may be performed.

Rules based engine/policy manager 202 defines the rules, which incorporate policy based principles, which are applied to determine whether intelligent transcoding can be performed. Rendering devices have different rendering capabilities. To account for this, rules based engine/policy manager 202 defines the applicable media formats in which a particular media format may be transcoded. Rules based engine/policy manager 202 also determines the required platform usage for a particular format conversion.

In one embodiment, the rules that are used in rules based engine/policy manager 202 are implemented in XML (extensible markup language). Implementing the rules in XML provides an operator the ability to modify the rules with little effort.

Network throughput is a measure, in bits per second, of the traffic carrying capacity of the network. Network throughput engine 204 determines network bandwidth availability. By knowing the available throughput of the network, the transcoding bit rate may be adjusted dynamically during intelligent transcoding. For example, if the source content format is a MPEG-2 transport stream with a bit rate of 6 Mbps and the rendering device supports MPEG-2 transport stream, but the network availability is 3 Mbps, the network cannot support the source content. In this instance, transcoding engine 208 does not have to transcode the source content because both the source and the rendering device support MPEG-2 transport stream. Instead, transcoding engine 208 has to perform transrating to lower the bit rate of the source content. In other words, transcoding engine 208 needs to drop the bit rate of the source content from 6 Mbps down to 3 Mbps to enable the source content to be streamed to the rendering device.

Thus, network throughput engine 204 will determine the available bit rate or bandwidth on the network and feed that information back into transcoding engine 208. Transcoding engine 208 will analyze the information from network throughput engine 206, along with the input from policy manager 202, to make decisions as to whether or not there is enough network throughput to send the data to the rendering device.

Platform usage engine 206 determines the current load on the processor, how much processor power is currently available, how much memory is available, and whether intelligent transcoding can be done given such processor and memory usage. For example, if content is to be streamed on two devices, such as device 124-1 and device 128-2, but the processor does not have the capability to transcode media to both devices 124-1 and 128-2, then platform usage engine 206 will provide transcoding engine 208 with the available platform usage, and transcoding engine 208 will determine which rendering device, if any, can be accommodated.

Thus, the information obtained from rules based engine/policy manager 202, network throughput 204, and platform usage 206 each contribute to intelligently transcoding digital media and are input data for transcoding engine 208. Transcoding engine 208 will, in turn, decide which format to convert to, what the bitrate format should be, whether the resolution needs to be altered (e.g., high definition (HD) to standard definition (SD)), whether the packaging of the media format needs to be changed, whether the DRM/copy protection scheme needs to be changed, and whether the network has the capacity to perform the transcoding. If transcoding engine 208 decides that the capability is available, transcoding engine 208 will intelligently transcode the data and stream the data to the rendering device, such as, for example, rendering device 124-1, 124-2, or 124-3, directly or via digital media renderer 122.

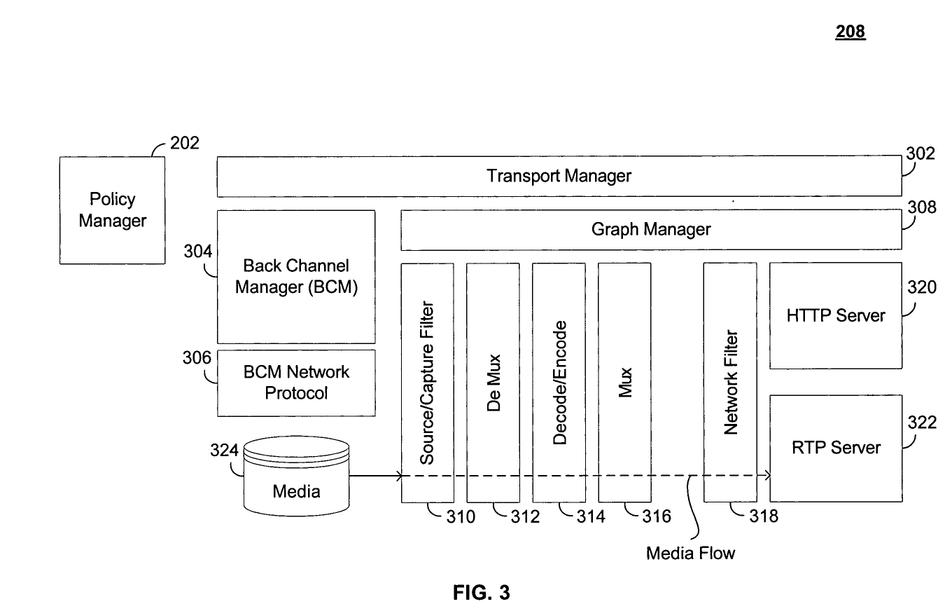

FIG. 3 is a block diagram 208 illustrating an exemplary intelligent transcoding engine according to an embodiment of the present invention. Transcoding engine 208 may be implemented in software, hardware, or a combination thereof. Transcoding engine 208 comprises policy manager 202, a transport manager 302, a back channel manager (BCM) 304, a BCM network protocol 306, a graph manager 308, a HTTP (Hypertext Transport Protocol) server 320, and a RTP (Real Time Transport Protocol) server 322.

As previously indicated, policy manager 202 includes rules that define the applicable media formats in which a particular media format may be transcoded and determines the required platform usage for a particular format conversion. Transport manager 302 is responsible for communicating with an application layer (not shown), such as, for example, UPnP for determining device characteristics. Back channel manager (BCM) 304 is responsible for communicating out of band communications or commands. For example, commands not supported by UPnP, such as, for example, autostop notifications and trick mode commands (e.g., fast forward, rewind, seek), may be handled by BCM 304. BCM network protocol 306 is used to provide the appropriate protocol to enable BCM to handle out of band communications or commands.

Transport manager 302 gathers the information from policy manager 202, network throughput 204, and platform usage 206 and communicates this information to graph manager 308. Graph manager 308 then puts together a graph or infrastructure for intelligent transcoding. Graph manager 308 includes a source/capture filter 310, a demultiplexer 312, a decode/encode 314, a multiplexer 316, and a network filter 318. Intelligent transcoding is performed using source/capture filter 310, demultiplexer 312, decode/encode 314, multiplexer 316, and network filter 318. Source/capture filter 310 receives media data 324 as input and filters the media data. Demultiplexer 312 separates the media data into video and audio components. Decode/Encode 314 decodes the media format and intelligently transcodes the media format based on the infrastructure designated by graph manager 308. Again, intelligent transcoding includes decoding, encoding, transrating, transformatting, transcripting, and transcaling. In the case of decoding, in an embodiment, a full decode to raw video bits may be performed or decoding may be performed to a degree where commonality between the streams can be used to partially decode and re-encode from that point. Multiplexer 316 combines the intelligently transcoded video and audio together. Network filter 318 filters the media signal. HTTP server 320 and RTP server 322 put the filtered media data onto the network for streaming to the rendering devices, such as, for example rendering devices 124-1, 124-2, and 124-3. HTTP server 320 is a pull model for when clients request data. RTP server 322 is a push model for enabling the server to push data onto the client side.

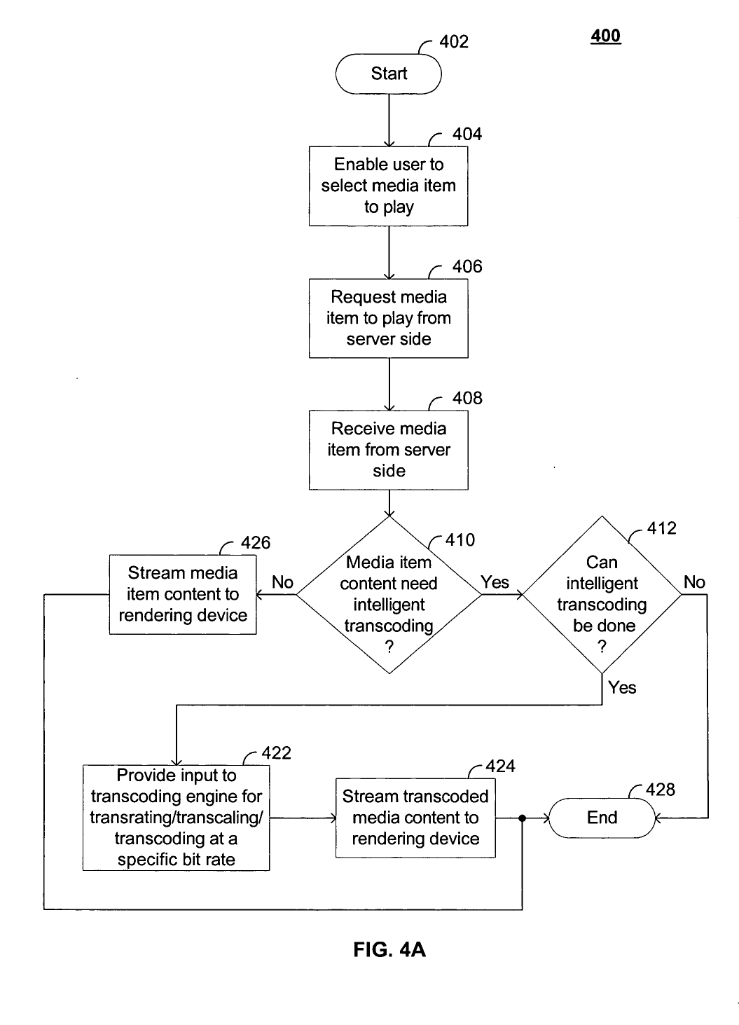

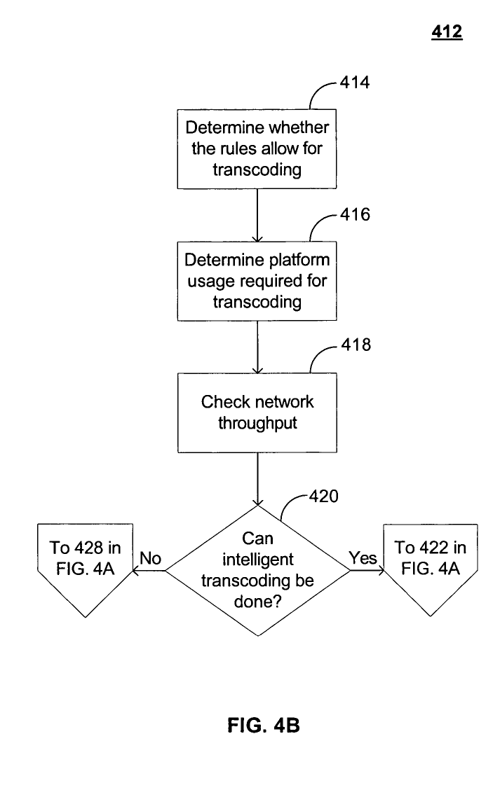

FIG. 4A is a flow diagram 400 illustrating a method for intelligent transcoding of video and audio streams from one format to another according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, a user is enabled to select a media item that the user desires to have played on a particular rendering device. A request for the media item to be played is made to the server side in block 406. In block 408, the media item is received from the server side. The process then proceeds to decision block 410.

In decision block 410, it is determined whether the media item received needs intelligent transcoding in order to be played on the rendering device. In order to determine whether intelligent transcoding is needed, the device capabilities of the rendering device or devices must be determined. As previously indicated, this may be accomplished using UPnP control point and discovery methods. Alternatively, other methods may be used to determine the device capabilities, such as, but not limited to, using a metadata server to discover rendering device capabilities. If the media item received needs intelligent transcoding in order to be played on the rendering device, the process proceeds to decision block 412.

In decision block 412, it is determined whether intelligent transcoding of the media item may be performed.

FIG. 4B is a flow diagram 412 describing a method for determining whether intelligent transcoding may be performed. The invention is not limited to the embodiment described herein with respect to flow diagram 412. Rather, it will be apparent to persons skilled in the relevant art(s) after reading the teachings provided herein that other functional flow diagrams are within the scope of the invention. The process begins with block 414, where the rules in policy manager 202 are examined to determine whether intelligent transcoding may be performed. If the rules allow for transcoding, policy manager 202 will then provide the required platform usage for transcoding. The process then proceeds to block 416.

In block 416, it is determined whether the required platform usage to perform the transcoding is available. As previously indicated, the platform usage looks to available processor power and memory to determine whether there is the capacity to perform the transcoding. The process then proceeds to block 418.

In block 418, network throughput is examined to determine whether there is enough bandwidth in the network to perform the transcoding. The process then proceeds to decision block 420.

In decision block 420, it is determined whether intelligent transcoding can be performed given the rules, the required platform usage, the platform capacity available, and network throughput. If intelligent transcoding can be performed, the process proceeds to block 422 in FIG. 4A. If intelligent transcoding cannot be performed, the process proceeds to block 428 in FIG. 4A.

Returning to FIG. 4A, block 412, if it is determined that intelligent transcoding of the media item may be performed, the process then proceeds to block 422.

In block 422, the media content is input to transcoding engine 208 for performing one or more of transrating, transcaling, transformatting, transcripting, and transcoding. In block 424, the transcoded media content is streamed to the rendering device. The process then proceeds to block 428, where the process ends.

Returning to decision block 412, if it is determined that intelligent transcoding may not be performed, the process proceeds to block 428, where the process ends.

Returning to decision block 410, if it is determined that the media content received from the server side does not need intelligent transcoding, then the process proceeds to block 426. In block 426, the media content is streamed to the appropriate rendering device. The process then proceeds to block 428, where the process ends.

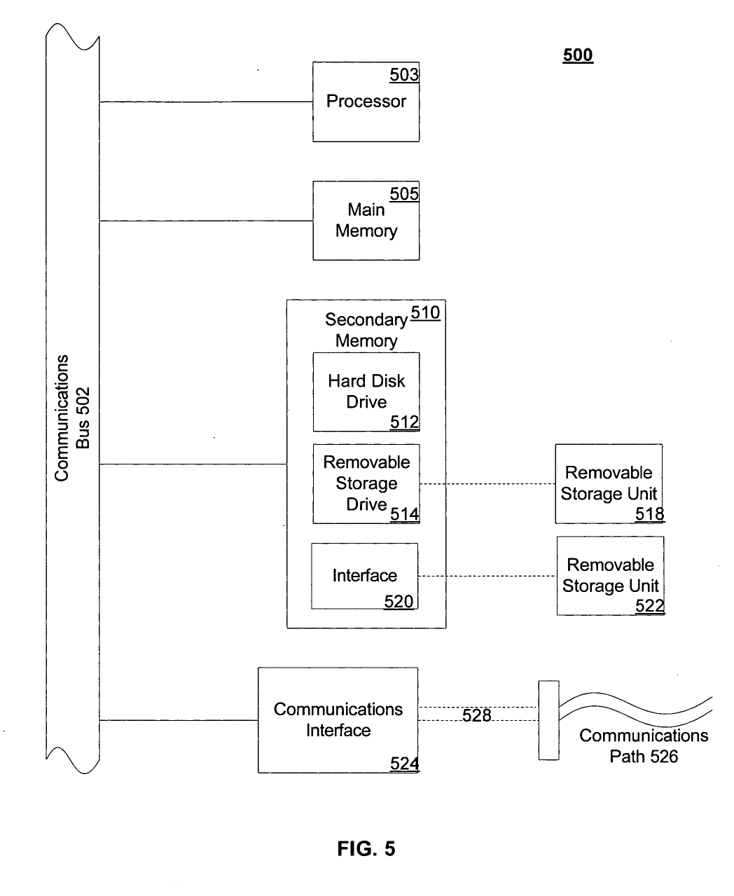

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 500 is shown in FIG. 5. Various embodiments are described in terms of this exemplary computer system 500. After reading this description, it will be apparent to a person skilled in the relevant art how to implement the invention using other computer systems and/or computer architectures.

Computer system 500 includes one or more processors, such as processor 503. Processor 503 is connected to a communication bus 502. Computer system 500 also includes a main memory 505, preferably random access memory (RAM) or a derivative thereof (such as SRAM, DRAM, etc.), and may also include a secondary memory 510. Secondary memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well-known manner. Removable storage unit 518 represents a floppy disk, magnetic tape, optical disk, etc., which is read by and written to by removable storage drive 514. As will be appreciated, removable storage unit 518 includes a computer usable storage medium having stored therein computer software and/or data.

In alternative embodiments, secondary memory 510 may include other similar means for allowing computer programs or other instructions to be loaded into computer system 500. Such means may include, for example, a removable storage unit 522 and an interface 520. Examples of such may include a program cartridge and cartridge interface (such as that found in video game devices), a removable memory chip (such as an EPROM (erasable programmable read-only memory), PROM (programmable read-only memory), or FLASH memory) and associated socket, and other removable storage units 522 and interfaces 520 which allow software and data to be transferred from removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a PCMCIA (personal computer memory card international association) slot and card, a wireless LAN (local area network) interface, etc. Software and data transferred via communications interface 524 are in the form of signals 528 which may be electronic, electromagnetic, optical or other signals capable of being received by communications interface 524. These signals 528 are provided to communications interface 524 via a communications path (i.e., channel) 526. Channel 526 carries signals 528 and may be implemented using wire or cable, fiber optics, a phone line, a cellular phone link, a wireless link, and other communications channels.

In this document, the term “computer program product” refers to removable storage units 518, 522, and signals 528. These computer program products are means for providing software to computer system 500. Embodiments of the invention are directed to such computer program products.

Computer programs (also called computer control logic) are stored in main memory 505, and/or secondary memory 510 and/or in computer program products. Computer programs may also be received via communications interface 524. Such computer programs, when executed, enable computer system 500 to perform the features of the present invention as discussed herein. In particular, the computer programs, when executed, enable processor 503 to perform the features of embodiments of the present invention. Accordingly, such computer programs represent controllers of computer system 500.

In an embodiment where the invention is implemented using software, the software may be stored in a computer program product and loaded into computer system 500 using removable storage drive 514, hard drive 512 or communications interface 524. The control logic (software), when executed by processor 503, causes processor 503 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. A multimedia conversion method comprising:
enabling a user to select a media item that the user desires to have played on a particular rendering device on a network;
requesting the media item from a service provider;
receiving the media item;
determining whether the media item needs intelligent transcoding to be played on the particular rendering device, wherein if the media item needs intelligent transcoding, then intelligently transcoding the media item, wherein intelligent transcoding includes one or more of transcoding, transcaling, transrating, transformatting, and transcripting; and
streaming the media item to the particular rendering device.

2. The method of claim 1, wherein determining whether the media item needs intelligent transcoding to be played on the particular rendering device further comprises determining whether intelligent transcoding can be performed.

3. The method of claim 2, wherein determining whether intelligent transcoding can be performed comprises:
determining whether the format of the media item can be transcoded;
determining whether the required platform usage to perform intelligent transcoding is available; and
determining whether there is enough bandwidth on the network to perform intelligent transcoding.

4. The method of claim 3, wherein determining whether the format of the media item can be transcoded comprises using a rules engine to look up rules, based on policy, to determine whether the format of the media item can be transcoded.

5. The method of claim 1, wherein determining whether the media item needs intelligent transcoding to be played on the particular rendering device includes determining device capabilities for the particular rendering device and determining whether the media format of the media item can be played on the particular rendering device.

6. The method of claim 5, wherein control points and discovery methods are used to determine the device capabilities.

7. The method of claim 5, wherein a metadata server is used to determine the device capabilities.

8. The method of claim 1, wherein transcaling comprises changing the resolution of the media item.

9. The method of claim 1, wherein transrating comprises changing or reducing the bitrate of the media item.

10. The method of claim 1, wherein transcoding comprises converting the format of the media item into another media format.

11. The method of claim 1, wherein transformatting comprises converting packaging of the media format to another media packaging format.

12. The method of claim 1, wherein transcripting comprises converting a Digital Rights Management (DRM)/copy protection scheme to another DRM/copy protection scheme.

13. An article comprising: a storage medium having a plurality of machine accessible instructions, wherein when the instructions are executed by a processor, the instructions provide for enabling a user to select a media item that the user desires to have played on a particular rendering device on a network;
requesting the media item from a service provider;
receiving the media item;
determining whether the media item needs intelligent transcoding to be played on the particular rendering device, wherein if the media item needs intelligent transcoding, then intelligently transcoding the media item, wherein intelligent transcoding includes one or more of transcoding, transcaling, transrating, transformatting, and transcripting; and
streaming the media item to the particular rendering device.

14. The article of claim 13, wherein instructions for determining whether the media item needs intelligent transcoding to be played on the particular rendering device further comprises instructions for determining whether intelligent transcoding can be performed.

15. The article of claim 14, wherein instructions for determining whether intelligent transcoding can be performed comprises instructions for:
determining whether the format of the media item can be transcoded;
determining whether the required platform usage to perform intelligent transcoding is available; and
determining whether there is enough bandwidth on the network to perform intelligent transcoding.

16. The article of claim 15, wherein instructions for determining whether the format of the media item can be transcoded comprises instructions for using a rules engine to look up rules, based on policy, to determine whether the format of the media item can be transcoded.

17. The article of claim 13, wherein instructions for determining whether the media item needs intelligent transcoding to be played on the particular rendering device includes instructions for determining device capabilities for the particular rendering device and determining whether the media format of the media item can be played on the particular rendering device.

18. The article of claim 17, wherein control points and discovery methods are used to determine the device capabilities.

19. The article of claim 17, wherein a metadata server is used to determine the device capabilities.

20. The article of claim 13, wherein transcaling comprises instructions for changing the resolution of the media item.

21. The article of claim 13, wherein transrating comprises instructions for changing or reducing the bitrate of the media item.

22. The article of claim 13, wherein transcoding comprises instructions for converting the format of the media item into another media format.

23. The article of claim 13, wherein transformatting comprises instructions for converting packaging of the media format to another media packaging format.

24. The article of claim 13, wherein transcripting comprises instructions for converting a Digital Rights Management (DRM)/copy protection scheme to another DRM/copy protection scheme.

25. A conversion engine comprising:
a policy manager to provide rules defining applicable media formats in which a particular media format can be transcoded;
a transport manager to gather information from the policy manager, to determine network throughput and platform usage required to perform intelligent transcoding, and to communicate with an application to provide device characteristics and policy information to a graph manager, wherein intelligent transcoding includes one or more of transcoding, transcaling, transrating, transformatting, and transcripting to transform a media format from a service provider to another media format for a rendering device for playing media on the rendering device;
wherein the graph manager puts together an infrastructure for intelligent transcoding and enables intelligent transcoding to be performed.

26. The conversion engine of claim 25, wherein the graph manager comprises:
a capture filter to capture media input;
a demultiplexer to separate the media input into video and audio components;
a decode/encode to decode the video and audio components and intelligent transcode the video and audio components based on the infrastructure generated by the graph manager;
a multiplexer to combine the transcoded video and audio components into media data; and
a network filter to filter the media data for streaming to the rendering device.

27. The conversion engine of claim 26, wherein the media data is streamed using HTTP (Hypertext Transport Protocol).

28. The conversion engine of claim 26, wherein the media data is streamed using RTP (Real-Time Transport Protocol).

29. The conversion engine of claim 25, further comprising a back channel manager to communicate out of band commands to applications.

30. The conversion engine of claim 25, wherein the policy manager determines a required platform usage for a particular media format conversion.

31. A home network comprising:
a controller to control the flow of digital multimedia content from one or more service providers;
a plurality of rendering devices, coupled to the controller, to play the digital multimedia content; and
a media renderer to connect one or more of the plurality of rendering devices to the controller;
wherein the controller comprises an intelligent transcoding engine to transcode the digital multimedia content from an original media format to a format suitable for at least one of the rendering devices.

32. The home network of claim 31, wherein the controller comprises at least one of a media center, a set top box, a personal computer, a home server, and a workstation.

33. The home network of claim 31, wherein the one or more rendering devices connected to the controller by the media renderer are incapable of directly connecting to the controller.

34. The home network of claim 31, wherein the intelligent transcoding engine is used for intelligent transcoding, wherein intelligent transcoding comprises one or more of transcoding, transcaling, transrating, transformatting, and transcripting.

35. The home network of claim 34, wherein transcoding comprises converting the format of the digital multimedia content into another media format.

36. The home network of claim 34, wherein transcaling comprises changing the resolution of the digital multimedia content.

37. The home network of claim 34, wherein transrating comprises changing or reducing the bitrate of the digital multimedia content.

38. The home network of claim 34, wherein transformatting comprises converting packaging of the media format to another media packaging format.

39. The home network of claim 34, wherein transcripting comprises converting a Digital Rights Management (DRM)/copy protection scheme to another DRM/copy protection scheme.
